(19) United States
(12) Patent Application Publication
(10) Pub. No.: US 2017/0083567 A1
(43) Pub. Date: Mar. 23, 2017

(54) HIGH-DIMENSIONAL DATA STORAGE AND RETRIEVAL

(71) Applicant: THERMOPYLAE SCIENCES AND TECHNOLOGY, North Arlington, VA (US)

(72) Inventor: Nicholas W. Knize, Rockwall, TX (US)

(73) Assignee: THERMOPYLAE SCIENCES AND TECHNOLOGY, North Arlington, VA (US)

(21) Appl. No.: 15/267,824

(22) Filed: Sep. 16, 2016

Related U.S. Application Data
(60) Provisional application No. 62/220,348, filed on Sep. 18, 2015.

(51) Int. Cl. G06F 17/30

(52) U.S. Cl. CPC G06F 17/30377; G06F 17/30327; G06F 17/30333

(57) ABSTRACT

Computer-implemented techniques for efficiently inserting high dimensional data into a tree data structure while managing hardware memory usage are presented. The techniques include accessing an electronically stored tree data structure indexing data having a dimension greater than three: electronically storing a node size threshold value, a memory consumption threshold value, a percentage overlap threshold value, a squareness threshold value, and a child node count threshold value; obtaining high dimensional data for insertion into the tree data structure; selecting a node of the tree data structure for insertion of the high dimensional data; inserting the high dimensional data into a node of the tree data structure; and determining, based on the node size threshold, the memory consumption threshold, the percentage overlap threshold the squareness threshold, and the child node count threshold, whether to split the node of the tree data structure.

### RELATED APPLICATION

This application claims the benefit of and priority to U.S. Provisional Patent Application No. 62/220,348 filed Sep. 18, 2015 and entitled, “High-Dimensional Data Storage and Retrieval”, which is hereby incorporated by reference in its entirety.

### FIELD OF THE INVENTION

This invention relates generally to electronically storing and retrieving large amounts of high-dimensional data.

### SUMMARY OF EXAMPLE EMBODIMENTS

According to some embodiments, a method of efficiently inserting high dimensional date into a tree data structure while managing hardware memory usage is presented. The method includes accessing an electronically stored tree data structure indexing data having a dimension greater than three; electronically storing a node size threshold value, memory consumption threshold value, a percentage overlap threshold value, a squareness threshold value, and a child node count threshold value: obtaining high dimensional data for insertion into the tree data structure; selecting a node of the tree data structure for insertion of the high dimensional data; inserting the high dimensional data into a node of the tree data structure; and determining whether to split the node of the tree data structure. The determining whether to split the node includes: determining whether a size of the node of the tree data structure exceeds the node size threshold value; determining whether a volatile memory usage exceeds the memory consumption threshold; determining whether a number of child nodes of the node of the tree data structure exceeds the child node count threshold value; determining whether a percent overlap of a minimal bounding rectangle for at least a portion of the high dimensional data in a node resulting from a provisional split exceeds the percentage overlap threshold value; and determining whether a squareness of a minimal bounding rectangle for at least a portion of the high dimensional data in a node resulting from a provisional split exceeds the squareness threshold value. The method also includes splitting the node of the tree data structure if the determining whether to split the node of the tree data structure results in a positive determination, otherwise not splitting the node of the tree data structure.

The method may include revising dynamically at least one of: the percentage overlap threshold value, the node size threshold value, the squareness threshold value, or the memory consumption threshold value. The revising dynamically may include: detecting that a percentage of nodes subject to insertion resulting in a split exceeds an electronically stored split threshold value; and narrowing a node split requirement by revising at least one of: the percentage overlap threshold value, the node size threshold value, the squareness threshold value, or the memory consumption threshold value.

The method may include retrieving at least a portion of the high dimensional data from the node of the tree data structure.

The selecting a node may include: determining a set of candidate nodes; and determining a subset of candidate nodes that would not require enlargement of respective minimal bounding rectangles in order to accommodate an insertion of the high dimensional data. The method may include, if the subset of candidate nodes is empty, ranking the set of candidate nodes according to at least a number of child nodes and a memory usage. Such a ranking may include ranking lexicographically according to at least a number of child nodes and a memory usage. The method may include, if the subset of candidate nodes is non-empty, ranking the subset of candidate nodes according to at least a percentage overlap, a squareness, a number of child nodes, and a memory usage. Such a ranking may include ranking lexicographically according to at least a percentage overlap, a squareness, a number of child nodes, and a memory usage.

The high dimensional data may include data having a dimension of at least four.

According to various embodiments, a system for efficiently inserting high dimensional data into a tree data structure while managing hardware memory usage is presented. The system includes at least one electronic volatile memory; and at least one electronic processor communicatively coupled to the at least one electronic volatile memory, where the at least one processor is configured to access an electronically stored tree data structure indexing data having a dimension greater than three; electronically store a node size threshold value, a memory consumption threshold value, a percentage overlap threshold value, a squareness threshold value, and a child node count threshold value; obtain high dimensional data for insertion into the tree data structure; select a node for insertion of the high dimensional data; and insert the high dimensional data into a node of the tree data structure. The at least one processor is further configured to determine whether to split the node of the tree data structure by: determining whether a size of the node of the tree data structure exceeds the node size threshold value; determining whether a volatile memory usage exceeds the memory consumption threshold; determining whether a number of child nodes of the node of the tree data structure exceeds the child node count threshold value; determining whether a percent overlap of a minimal bounding rectangle for at least a portion of the high dimensional data in a node resulting from a provisional split exceeds the percentage overlap threshold value; and determining,g whether a squareness of a minimal bounding rectangle for at least a portion of the high dimensional data in a node resulting from a provisional split exceeds the squareness threshold value. The at least one processor is further configured to split the node of the tree data structure if the determining whether to split the node of the tree data structure results in a positive determination, otherwise not split the node of the tree data structure.

The at least one processor may be further configured to revise dynamically at least one of: the percentage overlap threshold value, the node size threshold value, the squareness threshold value, or the memory consumption threshold value. The at least one processor configured to revise dynamically may be further configured to: detect that a percentage of nodes subject to insertion resulting in a split exceeds an electronically stored split threshold value; and narrow a node split requirement by revising at least one of: the percentage overlap threshold value, the node size threshold value, the squareness threshold value, or the memory consumption threshold value.

The at least one processor may further configured to retrieve at least a portion of the high dimensional data from the node of the tree data structure.

The at least one processor configured to select a node may be further configured to: determine a set of candidate nodes; and determine a subset of candidate nodes that would not require enlargement of respective minimal bounding rectangles in order to accommodate an insertion of the high dimensional data. The at least one processor configured to select a node may be further configured to, if the subset of candidate nodes is empty, rank the set of candidate nodes according to at least a number of child nodes and a memory usage. Such a ranking may include ranking lexicographically according to at least a number of child nodes and a memory usage. The at least one processor configured to select a node may be further configured to, if the subset of candidate nodes is non-empty, rank the subset of candidate nodes according to at least a percentage overlap, a squareness, a number of child nodes, and a memory usage. Such a ranking may include ranking lexicographically according to at least a percentage overlap, a squareness, a number of child nodes, and a memory usage.

The high dimensional data may include data having a dimension of at least four.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 depicts an example computer system in accordance with various embodiments;

FIG. 2 is a flow diagram depicting a data insertion process according to various embodiments;

FIG. 3 is a flow diagram depicting a process for selecting a node into which data is to be inserted according to various embodiments; and

FIG. 4 is a flow diagram depicting a process for determining whether to spit a node into which data has been inserted according to various embodiments.

### DESCRIPTION OF EXAMPLE EMBODIMENTS

Reference will now be made in detail to the present embodiments (exemplary embodiments) of the invention, examples of which are illustrated in the accompanying drawings. Wherever possible, the same reference numbers will be used throughout the drawings to refer to the same or like parts. In the following description, reference is made to the accompanying drawings that form a part thereof, and in which is shown by way of illustration specific exemplary embodiments in which the invention may be practiced. These embodiments are described in sufficient detail to enable those skilled in the art to practice the invention and it is to be understood that other embodiments may be utilized and that changes may be made without departing from the scope of the invention. The following description is, therefore, merely exemplary.

Acquired geographic data can be quite large. For example, the U.S. Army's Constant Hawk surveillance system can acquire roughly seven terabytes of multidimensional data per hour. Storing such data in a manner that permits efficient searches poses engineering challenges. Some systems store data in a tree structure. Example such tree structures include R-trees and X-trees.

R-trees organize any-dimensional data by representing the data as a minimum bounding box. Each node bounds its children. A node can have many objects in it. Splits and merges may be optimized by minimizing overlaps. The leaves may point to the actual objects. Such trees may be height balanced such that a search may be performed in O(log n) time.

X-trees are particularly suited for high dimensional data (e.g., three-dimensional, four-dimensional, or higher-dimensional). X-trees may have a maximum number of child nodes from each node (e.g., four). X-trees try to avoid minimum bounding rectangle overlaps. In general, the worst-case scenario with respect to many overlaps may cause read operations to be on the order of O(n). Further, X-trees generally try to avoid node splits, in favor of generating so-called supernodes, e.g., overlarge nodes. In general X-trees have superior page access and CPU-time performance in comparison to R-trees.

Inserting new data into a tree structure can sometimes result in overlarge tree leaf nodes. Some embodiments provide techniques for determining whether inserting data into a tree leaf node necessitates splitting such a node. Further, some embodiments extend R-tree and X-tree structures and operations to provide more efficient data insertion. Accordingly, some embodiments solve a computer-specific problem relating to the storage of large multidimensional data in a tree structure that permits efficient searching.

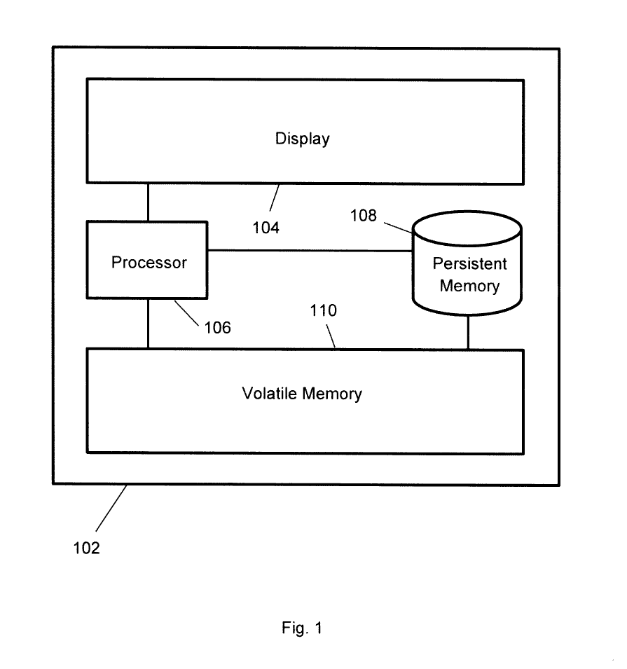

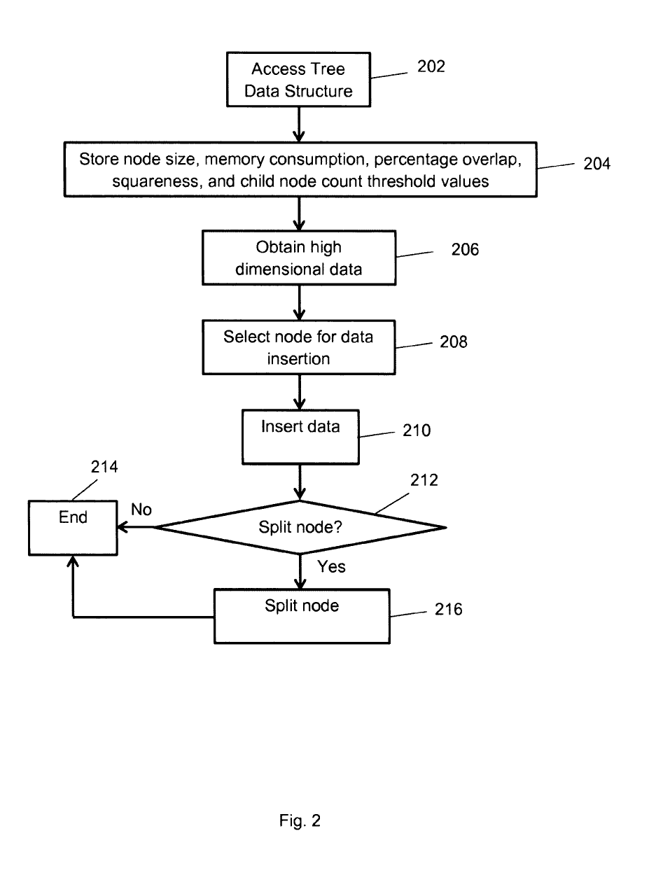

FIG. 1 depicts example computer system 102 in accordance with various embodiments. The system of FIG. 1 may implement any of the processes shown and described in reference to FIGS. 2-4.

As shown in FIG. 1, system 102 includes one or more electronic processors 106, which may include a plurality of parallel processors, e.g., processing cores. Electronic processors 106 may be configured to perform, at least in part, the methods disclosed herein. System 102 also includes persistent memory 108, which may include one or more hard disk drives, for example. Persistent memory may be coupled to processors 106 and to volatile memory 110. Volatile memory may be random access memory, for example, and may be further coupled to processors 106. System 102 may further include one or more display(s) 104. Display 104 may be coupled to processors 106, for example. Display 104 may further be coupled to display volatile memory, for example.

Some embodiments reduce the need for system 102 to utilize persistent memory 108 for swap files. Instead, some embodiments utilize volatile memory 110 in an agile manner. Because system 102, and computers in general, store and retrieve data from volatile memory 110 much faster than from persistent memory 108, these embodiments are more efficient and faster than prior art systems.

FIG. 2 is a flow diagram depicting a data insertion process according to various embodiments. The process depicted by FIG. 2 may be implemented using the system depicted by FIG. 1.

In general, the process of FIG. 2 may be used to insert high-dimensional data (i.e., dimension three or higher) into a search tree. The process of FIG. 2 may be used to determine whether to split a tree node into which the data was inserted. Such splitting allows the tree to be balanced and readily searchable.

At block 202, the process accesses the tree data structure. The tree may have the structure of an X-tree, an R-tree, or a different searchable tree, for example. (Note that the structure of the tree is essentially independent from the permissible operations on the tree. Disclosed embodiments utilize an insert operation that differs from the split operations of existing tree structures.) The tree may encapsulate leaf node data in a minimal bounding rectangle. Each leaf node may link directly to record data. The process may access the tree by accessing it in persistent memory, for example. The accessing may include obtaining data from the tree, for example.

At block 204, the process stores threshold values for node size, memory consumption, percentage overlap squareness, and child node count. These threshold values may be stored in persistent memory, for example. At block 212, these threshold values are used to determine whether to split a tree node into which data was inserted.

At block 206, the process obtains high dimensional data. The data may represent a geographic map, for example. The map may include points that specify latitude, longitude, elevation, and other information, such as temperature, barometric pressure, ground cover type, etc. The dimension may be four or higher. The data may be obtained by retrieval from persistent memory, by acquisition over a computer network, or by other techniques.

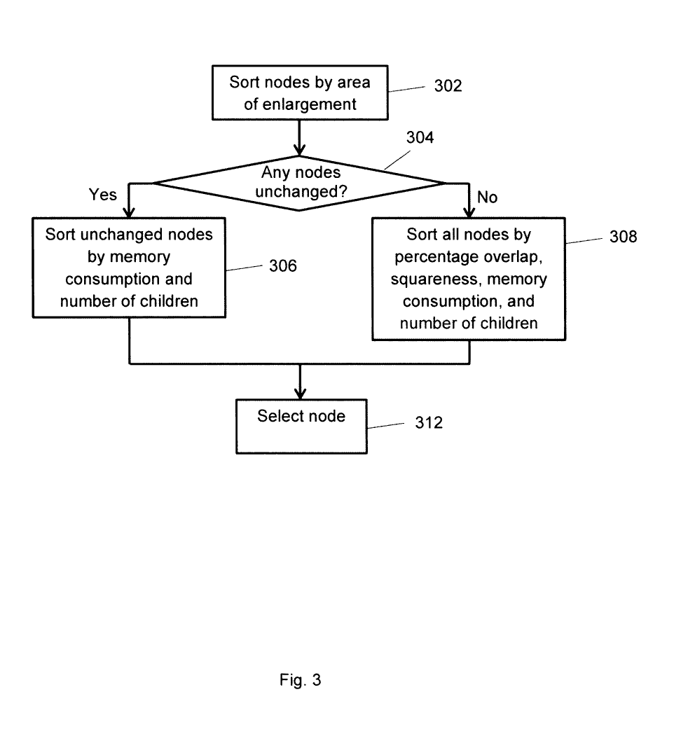

At block 208, the process selects a leaf node for insertion of the high dimensional data obtained at block 206. The node may be selected using the process shown and described below in reference to FIG. 3, for example.

At block 10, the process inserts the high dimensional data obtained at block 206 into the node selected at block 208. The insertion may be accomplished by recording in persistent memory for the selected node the high dimensional data in a manner that preserves the node structure.

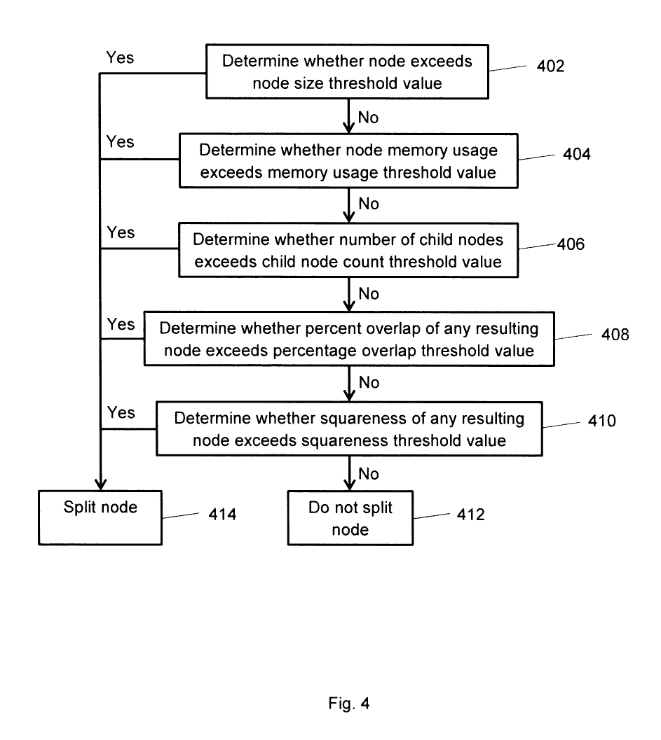

At block 212, the process determines whether to split the node into which the high dimensional data was inserted. The determination may be accomplished using the process shown and described below in reference to FIG. 4, for example. If the determination is negative, that is, if the node is not to be spot, then the process may branch to block 214 and end. Otherwise, if the determination is positive, that is, if the node is to be split, then the process branches to block 216.

At block 216, the process splits the node into which data was inserted. The split may be accomplished by generating a new leaf node, and inserting the split material into the newly generated leaf node. After block 216, the process branches to block 214 and end.

FIG. 3 is a flow diagram depicting a process for selecting a node into which data is to be inserted according to various embodiments. The process depicted by FIG. 3 may be implemented using the system depicted by FIG. 1. According to some embodiments, FIG. 3 describes the actions of block 208 from FIG. 2. That is, the process of FIG. 3 may be used to select a node into which data is inserted.

At block 302, the process sorts available nodes according to the additional area of enlargement that would occur if the data (of block 206 of FIG. 2) were inserted. That sorting may be from smallest to largest, for example.

At block 304, the process determines whether any nodes would be unchanged. That is, the process determines whether the minimum bounding rectangle of any node would be unchanged if the data were'inserted. This may be accomplished by inspecting the sorted nodes of block 302. Any unchanged nodes would appear at the beginning of the sorted list if the nodes are sorted from least change to greatest change. Thus, the determination of whether any nodes would be unchanged may proceed by inspection of the sorted nodes of block 302. If at least one unchanged node exists, then the process may branch to block 306. Otherwise, if all nodes would be changed by insertion of the data

At block 306, the process sorts the unchanged nodes according to memory consumption first and then number of children. That is, the process may sort the unchanged nodes lexicographically according to memory consumption and number of child nodes. This ordering may be represented symbolically as (# children, memory consumption). The process may then select a first node so ordered at block 312. Note that if an unchanged node exists, that is, if the process branches to block 306, then the node into which the data is inserted may not undergo a subsequent spit operation.

At block 308, the process sorts nodes according to percentage overlap, squareness, memory consumption, and number of children. The sorting may be lexicographic by the named parameters. According to some embodiments, the percentage overlap may be computed by determining the area of overlap of the minimal bounding rectangle with its node siblings, and dividing this quantity by the total area of the node and its siblings. According to some embodiments, the squareness may be computed as the ratio of side lengths of the minimal bounding rectangle. The number of child nodes may be computed by tallying the number of child nodes. Per block 308, the nodes are sorted lexicographically according to first percentage overlap, then squareness, then memory consumption, and finally number of children. This ordering may be represented symbolically as (% overlap, squareness, # children, memory consumption)ₗₑₓ. The process may then select a first node so ordered at block 312. Note that if no unchanged nodes exist, that is, if the process branches to block 308, then the node into which the data is inserted may undergo a subsequent split operation.

At block 312, the process selects a node for data insertion. The selected node may be the first node ordered according to the lexicographic sorting of blocks 306 or 308, depending on the branching of block 304. Note that after insertion, if the node's area is unchanged (i.e., if block 304 branches to block 306) then the node may not be subsequently split. Otherwise, if the node's area is changed (i.e., if block 304 branches to block 308) then the node may be subsequently split.

After block 312, the selection process of FIG. 3 may end.

FIG. 4 is a flow diagram depicting a process for determining whether to split a node into which data has been inserted according to various embodiments. The process depicted by FIG. 4 a implemented using the system depicted by FIG. 1. In some embodiments, FIG. 4 depicts the actions of block 212 of FIG. 2. That is, the process of FIG. 4 may be used to determine whether to split a node into which data was inserted.

At block 402, the process determines whether the node under consideration exceeds a node size threshold value. The node size threshold value may be set in advance and updated dynamically. The node size threshold value may be based on the area of the minimal bounding rectangle of the node. If the node under consideration exceeds the threshold size limit, then the process proceeds to block 414, and the node is split. Otherwise, the process branches to block 404.

At block 404, the process determines whether the memory usage of the node under consideration exceeds a memory usage threshold value. The memory usage threshold value may be set in advance and updated dynamically. If the node under consideration exceeds the memory usage threshold value after the insert, then the process proceeds to block 414 and the node is split. Otherwise, the process branches to block 406.

At block 406, the process determines whether the number of child nodes of the node under consideration exceeds a child node count threshold value. The child node count threshold value may be set in advance and updated dynamically. If the node under consideration exceeds the child node count threshold value, then the process proceeds to block 414, and the node is split. Otherwise the process branches to block 408.

At block 408, the process determines whether a percent overlap of the node under consideration would exceed a percentage overlap threshold value if the data were inserted. According to some embodiments, the percentage overlap may be computed by determining the area of overlap of the minimal bounding rectangle with its node siblings, and dividing this quantity by the total area of the node and its siblings. The percent overlap threshold value may be set in advance and updated dynamically. If the node under consideration exceeds the percent overlap threshold value, then the process proceeds to block 414, and the node is split. Otherwise, the process branches to block 410.

At block 410, the process determines whether the squareness of the node under consideration exceeds a squareness threshold value. According to some embodiments, the squareness may be computed as the ratio of side lengths of the minimal bounding rectangle. The squareness threshold value may be set in advance and updated dynamically. If the squareness of the node under consideration exceeds the squareness threshold value, then the process proceeds to block 414, and the node is split. Otherwise, the process branches to block 412.

At block 412, a determination is made not to split the node. This determination may be conveyed to the process of FIG. 2 at block 212, and block 212 may branch to block 214, ending without splitting the node.

At block 414, a determination is made to split the node. This determination may be conveyed to the process of FIG. 2 at block 212, and block 212 may branch to block 216, splitting the node.

Note that embodiments may update the threshold values dynamically. Initial threshold values may be set using a benchmarking process. Threshold updating may be accomplished by running statistical analysis of splits, e.g., how often an insertion results in a split or overflow “supernode”, e.g., a node that exceeds one or more threshold values. If splits or supernode creation occurs with excessive frequency, then the threshold values may be accordingly updated. For example, the percentage overlap threshold value may be updated by adding an increment (e.g., 5% or 10%) or by splitting the difference between the current threshold vale and 100%. Conversely, few splits may result in relaxing the threshold values, e.g., by subtracting an increment (e.g., 5% or 10%) or splitting the difference between the current threshold value and 0%.

Certain embodiments can be performed as a computer program or set of programs. The computer programs can exist in a variety of forms both active and inactive. For example, the computer programs can exist as software program(s) comprised of program instructions in source code, object code, executable code or other formats; firmware program(s), or hardware description language (HDL) files. Any of the above can be embodied on a transitory or non-transitory computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method can be performed in a different order than illustrated or simultaneously. These skilled in the art will recognize that these and other variations are possible within the spirit and scope as defined in the following claims and their equivalents.

What is claimed is:

1. A computer-implemented method of efficiently inserting high dimensional data into a tree data structure while managing hardware memory usage, the method comprising:
accessing, by at least one electronic processor, an electronically stored tree data structure indexing data having a dimension greater than three;
electronically storing a node size threshold value, a memory consumption threshold value, a percentage overlap threshold value, a squareness threshold value, and a child node count threshold value;
obtaining, by at least one electronic processor, high dimensional data for insertion into the tree data structure;
selecting, by at least one electronic processor, a node of the tree data structure for insertion of the high dimensional data;
inserting, by at least one electronic processor, the high dimensional data into a node of the tree data structure;
determining, by at least one electronic processor, whether to split the node of the tree data structure, where the determining whether to split the node comprises:
determining, by at least one electronic processor, whether a size of the node of the tree data structure exceeds the node size threshold value;
determining, by at least one electronic processor, whether a volatile memory usage exceeds the memory consumption threshold;
determining, by at least one electronic processor, whether a number of child nodes of the node of the tree data structure exceeds the child node count threshold value
determining, by at least one electronic processor, whether a percent overlap of as minimal bounding rectangle for at least a portion of the high dimensional data in a node resulting from a provisional split exceeds the percentage overlap threshold value; and
determining, by at least one electronic processor, whether a squareness of a minimal bounding rectangle for at least a portion of the high dimensional data in a node resulting from a provisional split exceeds the squareness threshold value; and
splitting, by at least one electronic processor, the node of the tree data structure if the determining whether to split the node of the tree data structure results in a positive determination, otherwise not splitting the node of the tree data structure.

2. The method of claim 1, further comprising:
revising dynamically at least one of: the percentage overlap threshold value, the node size threshold value, the squareness threshold value, or the memory consumption threshold value.

3. The method of claim 2, wherein the revising dynamically comprises:
detecting that a percentage of nodes subject to insertion resulting in a split exceeds an electronically stored split threshold value; and
narrowing a node spot requirement by revising at least one of: the percentage overlap threshold value, the node size threshold value, the squareness threshold value, or the memory consumption threshold value.

4. The method of claim 1, further comprising retrieving at least a portion of the high dimensional data from the node of the tree data structure.

5. The method of claim 1, wherein the selecting a node comprises:
determining a set of candidate nodes; and
determining a subset of candidate nodes that would not require enlargement of respective minimal bounding rectangles in order to accommodate an insertion of the high dimensional data.

6. The method of claim 5, wherein:
if the subset of candidate nodes is empty, ranking the set of candidate nodes according to at least a number of child nodes and a memory usage.

7. The method of claim 6, wherein the ranking comprises ranking lexicographically according to at least a number of child nodes and a memory usage.

8. The method of claim 5, wherein:
if the subset of candidate nodes is non-empty, ranking the subset of candidate nodes according to at least a percentage overlap, a squareness, a number of child nodes, and a memory usage.

9. The method of claim 8, wherein the ranking comprises ranking lexicographically according to at least a percentage overlap, a squareness, a number of child nodes, and a memory usage.

10. The method of claim 1, wherein the high dimensional data comprises data having a dimension of at least four.

11. An electronic computer system for efficiently inserting high dimensional data into a tree data structure while managing hardware memory usage, the system comprising:
at least one electronic volatile memory; and
at least one electronic processor communicatively coupled to the at least one electronic volatile memory, wherein the at least one processor is configured to:
access an electronically stored tree data structure indexing data having a dimension greater than three;
electronically store a node size threshold value, a memory consumption threshold value, a percentage, overlap threshold value, a squareness threshold value, and a child node count threshold value;
obtain high dimensional data for insertion into the tree data structure;
select a node for insertion of the high dimensional data;
insert the high dimensional data into a node of the tree data structure;
determine whether to split the node of the tree data structure by:
determining whether a size of the node of the tree data structure exceeds the node size threshold value;
determining whether a volatile memory usage exceeds the memory consumption threshold;
determining whether a number of child nodes of the node of the tree data structure exceeds the child node count the threshold value;
determining whether a percent overlap of a minimal bounding rectangle for at least a portion of the high dimensional data in a node resulting from provisional split exceeds the percentage overlap threshold value; and
determining whether a squareness of a minimal bounding rectangle for at least a podion of the high dimensional data in a node resulting from a provisional split exceeds the squareness threshold value; and
split the node of the tree data structure if the determining whether to split the node of the tree data structure results in a positive determination, otherwise not splitting the node of the tree data structure.

12. The system of claim 11, wherein the at least one processor is further configured to revise dynamically at least one of: the percentage overlap threshold value, the node size threshold value, the squareness threshold value, or the memory consumption threshold value.

13. The system of claim 12, wherein the at least one processor configured to revise dynamically is further configured to:
detect that a percentage of nodes subject to insertion resulting in a split exceeds an electronically stored split threshold value; and
narrow a node split requirement by revising at least one of: the percentage overlap threshold value, the node size threshold value, the squareness threshold value, or the memory consumption threshold value.

14. The system of claim 11, wherein the at least one processor is further configured to retrieve at least a portion of the high dimensional data from the node of the tree data structure.

15. The system of claim 11, wherein the at least one processor configured to select a node is further configured to:
determine a set of candidate nodes; and
determine a subset of candidate nodes that would not require enlargement of respective minimal bounding rectangles in order to accommodate an insertion of the high dimensional data.

16. The system of claim 15, wherein the at least one processor configured to select a node is further configured to:
if the subset of candidate nodes is empty, rank the set of candidate nodes according to at least a number of child nodes and a memory usage.

17. The system of clam 16, wherein the of least one processor configured to select a node is further configured to rank lexicographically according to at least a number of child nodes and a memory usage.

18. The system of claim 15, wherein the at least one processor configured to select a node is further configured to:
if the subset of candidate nodes is non-empty, rank the subset of candidate nodes according to at least a percentage overlap, a squareness, a number of child nodes, and a memory usage.

19. The system of claim 18, wherein the at least one processor configured to select a node is further configured to rank lexicographically according to at least a percentage overlap, a square less, a number of child nodes, and a memory usage.

20. The system of claim 11, wherein the high dimensional data comprises data having a dimension of at least four.
